(19) United States
(12) Patent Application Publication
(10) Pub. No.: US 2019/0077082 A1
(43) Pub. Date: Mar. 14, 2019

(54) STORAGE MODULES FOR 3D PRINTING SYSTEMS

(71) Applicant: HEWLETT-PACKARD DEVELOPMENT COMPANY, L.P., Houston, TX (US)

(72) Inventors: Anna TORRENT, Sant Cugat del Valles (ES); Cristian FERRIS ROIG, Sant Cugat del Valles (ES); Pau MARTIN VIDAL, Sant Cugat del Valles (ES); Alex RUIS LAORDEN, Sant Cugat del Valles (ES)

(73) Assignee: HEWLETT-PACKARD DEVELOPMENT COMPANY, L.P., Houston, TX (US)

(21) Appl. No.: 16/088,605

(22) PCT Filed: Feb. 27, 2017
(86) PCT No.: PCT/US2017/019593

§ 371 Date: Sep. 26, 2018

(51) Int. Cl. B29C 64/321; B29C 64/393

(52) U.S. Cl. CPC B29C 64/321; B33Y 50/02; B29C 64/393

(57) ABSTRACT

A storage module of a 3D printing system is disclosed, such module comprising a plurality of transducers located at different sensing positions within the storage module being the plurality of transducers connected to a processor; wherein a combined signal of the plurality of temperature transducers is determined and the processor is to correlate the combined signal to an amount of build material inside the storage module

### BACKGROUND

Additive manufacturing techniques, such as 3D printing, enable objects to be generated on a layer-by-layer basis. 3D printing techniques may generate a layer of an object by selectively solidifying a portion of a layer of a build material.

Some 3D printing systems comprise a printer and a build unit wherein build material is loaded and stored for further processing by means of a 3D printer to generate a 3D object.

In some cases, 3D printing systems comprise three parts: a build material processing unit, a printer and a build unit. In such cases, the 3D printing process starts in the material processing unit wherein, by means of such unit, a determined amount of build material is loaded into a storage module within the build unit. In essence, the build unit is where build material is stored and/or managed before the material is fed, to the printer itself and after the material is processed by means of the printer. The build unit may also perform other types of tasks for the management of the powder such as, for example, pre-heating the material before transferring it to the printer.

Once the build unit is loaded, the build unit may pre-heat the build material until s it is ready to be used by the printer. Then, once a print process is finished and a cooling time is elapsed, the build unit may return to the material processing unit to do the unpacking of the 3D printed parts, and refill the build unit for another use.

### BRIEF DESCRIPTION OF THE DRAWINGS

FIG. 1 is an schematic view of an example of a 3D printing system

FIG. 2 is a perspective view with a cross section of an example of 3D printing system.

FIG. 3A is an example of an electric circuit that allows for determining the amount of build material within a build unit.

FIG. 3B is a graph showing the signal obtained with the electric circuit of FIG. 3A.

### DETAILED DESCRIPTION

As mentioned above, the build unit may comprise a set of heaters to pre-heat the build material within the storage module of the build unit so that in the printing module, a lower amount of heating is needed thereby requiring less power to be used, e.g., in fusing lamps. The pre-heating process can generate temperatures of around 100° C. in some parts of the storage module.

In another example, the build unit is transferred to a location within a printer, such printer comprising heating elements that are connected to the build unit in such way that they heat the storage module.

A build unit may have the ability to determine the amount of build material that is stored given that material inside the build unit can, for example, leak out of the build unit due, e.g., to punctures or fissures of the container within the storage module. Such detection of the amount of build material may be designed to withstand the processing conditions of a 3D printing process, i.e., high temperatures and vibrating environments, amongst others.

Also, the storage module may provide real-time measurement of the amount of build material that is available in a unit without the need of expensive industrial level measurement electronics that may not be suitable for use in hot, vibrating and dirty environments.

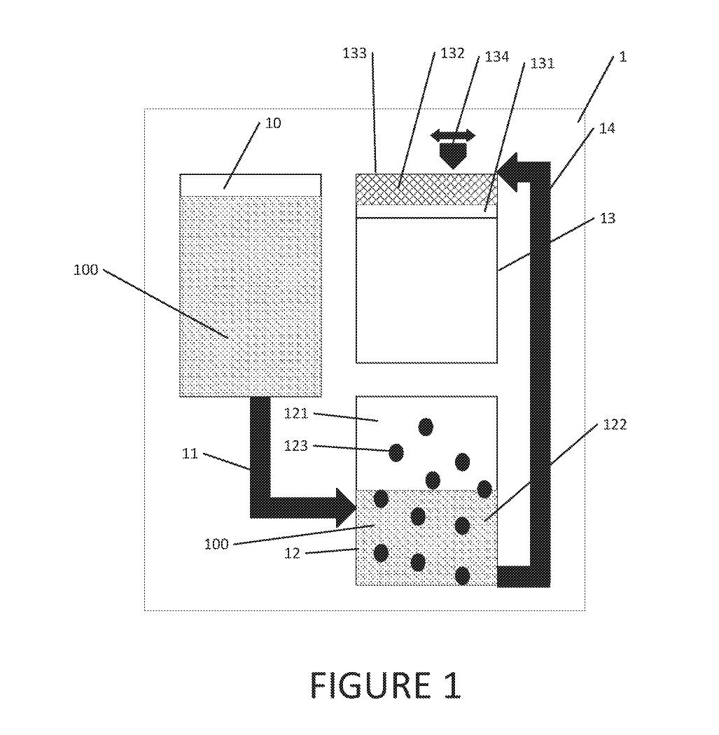

FIG. 1 shows a block diagram indicating an example of a printing system 1 wherein build material is first located in a material processing unit 10. From this material processing unit, build material 100 is transported through loading means 11 to a build unit 12 and, in particular, to a storage module that can be located in the printing module 13, or the build unit 12. The build unit 12 can comprise heaters and may have to operate with internal build material temperatures over 80° C., for example, over 100° C., thereby making it difficult to measure the amount of printing material 100 inside the build unit or, in particular, the storage module 12 using standard electronics such as, for example, laser systems for level detection.

A more explicit case arises when the build material 100 to be quantified is powder as is the case for some 3D printing devices. In such a case, it is possible that the upper surface of the build material within the storage module is not level, for example depending on how powder is extracted from the storage module. Therefore, a need for quantification of the build material at different levels may also be desirable.

From the storage module 12 build material 100 is transferred to a printing module 13, for example, by means of a conveyor 14 and the build material 100 is processed, for example by a fusing element 134 to generate processed material 132 which comprises 3D parts. In an example, a layer of build material 100 is deposited over a printing surface 131 and portions of that layer of build material are selectively fused. Then, the printing surface 131 is lowered and a new layer of build material 100 is deposited over the previously processed layer, and this process repeats itself until a 3D part is formed.

Also, FIG. 1 shows that within the storage module 12 there are two interfaces, a build material interface 122 and an air interface 121. Being the build material interface the part of the storage module 12 that comprises build material and the air interface 121, the part of the storage module 12 that does not have build material and, therefore, comprises mainly air.

As the build material 100 is conveyed to the printing module 13 for its printing, less build material remains within the storage module 12 and, therefore, an air interface 121 within the storage module 12 increases its volume and the build material interface 122 decreases its volume.

Given that build material 100 has a different thermal coefficient than air, it is possible to differentiate between the volume of the storage module 12 that comprises build material 100 and the volume of the storage module 12 that comprises air, i.e., determine the air interface 121 and the build material interface 122 by using, e.g., a temperature transducer. If the storage module is subjected to a temperature such as during a pre-heating, a temperature transducer located in the air interface would absorb more heat than a temperature transducer located in the build interface given that the build material surrounding such transducer would absorb part of the heat. This same principle applies also to other types of transducers

Once the interfaces are identified it is possible to determine the amount of build material 100 that is within the storage module 12.

An example provides that a set of temperature transducers 123 are located a different locations within the volume of the storage module 12. Those locations are, in an example, uniformly distributed within the volume of the storage module 12. As powder is removed from the bottom of the storage module 12, the portion of the storage module 12 defined as the air interface 121 increases and, therefore, a higher amount of transducers 123 are within such air interface 121. In another example the temperature transducers may be non-uniformly distributed within the volume of the storage module 12.

In one example, the transducers 123 may be connected to a processor that correlates the temperatures of the transducers 123 to build material quantity data. To correlate the data, the data of the transducers may be combined and a combined signal is formed. This combined signal is indicative of the mean temperature within the build unit 12 and, therefore, indicative of the quantity of build material 100 within the build unit 12.

In an example, the temperature transducers are thermistors and, furthermore, may be NTC (Negative Thermal Coefficient) resistors, i.e., a resistor whose resistance is dependent on temperature in which the resistance decreases with a temperature increase.

In an example, the aggregation signal is formed by means of hardware aggregation, e.g., by connecting the transducers in series. In this example, the combined signal, which is proportional to the mean temperature within the build unit 12, is indicative of the quantity of build material 100 within the build unit 12.

In another example, the aggregation signal may be formed by digital meas, such as computer implemented means within the processor, e.g., by combining the signals obtained from each transducer or, in a further example, by aggregating the amount of sensors that exceed a reference value and assigning to each transducer a corresponding determined volume of build material, then the volume of sensors exceeding reference value are indicative of the air or build material interface. The reference value may be determined, e.g., by a transducer known to be located in the air interface.

Furthermore, the processor may assign to each transducer a determined volume and if the transducer reports a value indicative of being in the air interface, the processor may assume that the volume assigned to such transducer does not comprise build material. Therefore, by aggregating the volumes of the sensors identified as being within the build material interface, the quantity of build material within the build unit is obtained.

In an example, a volume of 10 cm³ is assigned to a set of temperature transducers distributed uniformly within the volume of the storage module 12, furthermore, it is identified that five transducers are located within the air interface 121 (for example, if they have higher temperatures than a threshold temperature) and three are located in the build material interface 122. Therefore, it can be considered that the air interface 121 has a volume of 50 cm³ and the build material interface has a volume of 30 cm³, i.e., there is still a volume of 30 cm³ of build material 100 within the storage module 12.

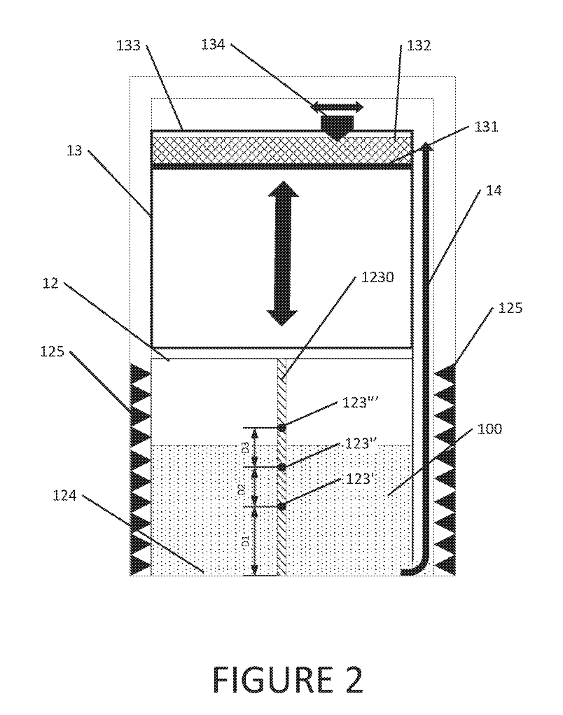

FIG. 2 shows an example of build unit located below a printing module 13. In this example the build material 100 is transferred from the storage container 12 through a conveyor 14 to the printing module 13, the material is transferred from the bottom 124 of the build unit to the upper section 133 of the printing module 13 being the upper section 133 a section above the printing surface 131.

In the example shown in FIG. 2, a plurality of temperature transducers 123, namely a first transducer 123′, a second transducer 123″ and a third transducer 123′″, are located at different heights D1, D2, D3, of the storage module 12. The transducers may be extended along a longitudinal direction, i.e., in a transducer strip 1230 or at different transversal positions for acquiring more spread data. In another example, the transducers may be extended along a wall of the storage module 12.

Alternatively, the transducers may be distributed within the volume inside the storage module 12, this distribution can be a uniform distribution or simply by having a higher amount of transducers in some determined sections of the build unit 12 such as, e.g., the sections with a special geometry or the lower sections to have a higher accuracy in the lowest levels of build material 100.

Also, in the example of FIG. 2, it is shown that the printing system 1 comprises heating elements that could be a heating blanket or any type of heater 125. In this case, the heaters 125 are external to the build unit, however, a build unit can also incorporate them. In this case, the heaters are part of the printing module 13 and are connected to the build unit such as to be able to heat to the storage container 12.

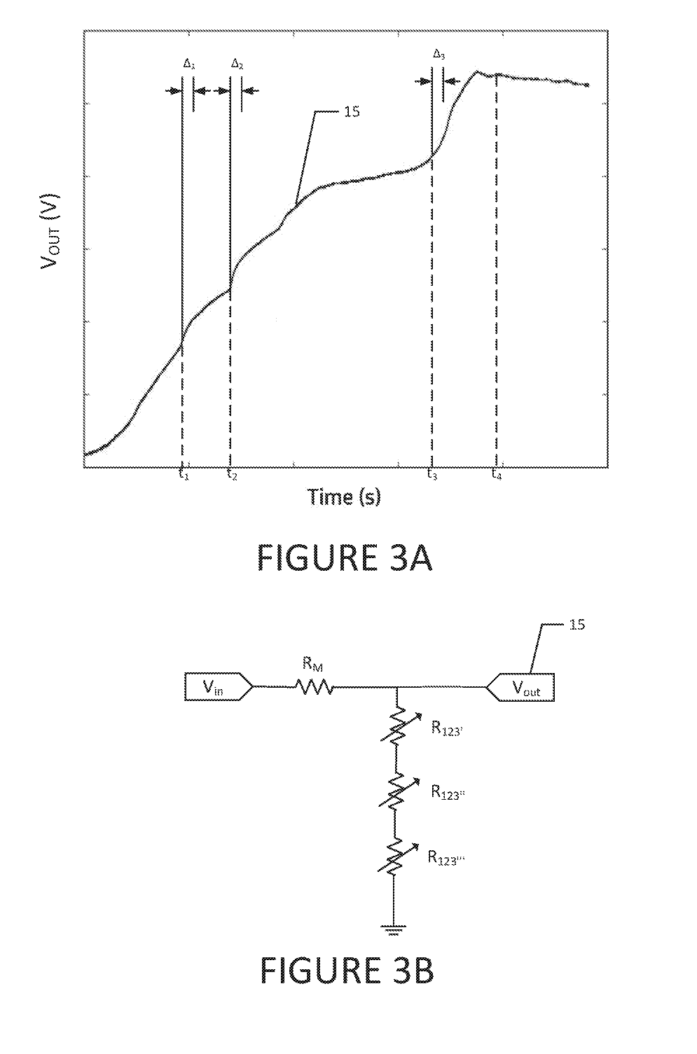

FIG. 3A illustrates an example of electric circuit to connect the transducers in series. The configuration shown in FIG. 3A allows to perform a hardware aggregation of the signals of the transducers. In this example three transducers 123′, 123″, 123′″ are connected in series, having variable resistances R_{123′}, R_{123′}, R_{123′″}, respectively wherein the resistance of these transducers is reduced as the temperature increases. Furthermore the circuit comprises a measuring resistor R_{M} and a voltage source Vᵢₙ. The combined signal 15 is, therefore, the signal acquired upon the measurement of the series of the transducers, indicated as V_{OUT}.

FIG. 3B shows a graph of the combined signal 15 obtained for the circuit of FIG. 3A in a 3D printing process. In this figure it is shown that the combined signal is zeroed at the start of the process and increases as the build material 100 is used in a 3D printing process since there are less heat absorbing elements (build material 100) in the storage module 12.

There are some particularly interesting elements that are shown in this graph, for instance, at time t₁, there is a high gradient for a period of time Δ₁ this happens when the build material 100 lowers so that the first sensor 123′ passes from being surrounded with build material 100 on the build material interface 122 to being exposed to the air in the air interface 121. Since, in this particular example, air has a lower heat absorption index than the build material, the temperature that the first transducer withstands becomes higher and causes a sudden increase in the temperature sensed by the transducer and, therefore, a high gradient. This same reasoning applies to the second sensor 123″ at time t2 for the period of time Δ₂ and for the third sensor 123′″ at t₃ during the period of time Δ3.

Also, when there is no build material 100 left in the storage module 12, all of the sensors are within the air interface 121 and since there is no change in the amount of build material 100 within the storage module 12 it is expected that the combined signal 15 remains substantially constant as can be seen from time t4 onwards.

As this combined signal 15 is obtained, it is sent to a processor that can be either part of the build material unit 12 itself, part of the printer 13, part of the material processing unit 10 or an external processor connected, for example, to a third-party device such as a computer connected to the printing system.

The processor may comprise means to correlate the combined signal to information relating the quantity of build material 100 left in the build unit. For example, the processor may be connected to a memory wherein a look-up table is stored wherein a value of combined signal (within a defined tolerance) corresponds to a volume of build material. Another example is that the processor performs an algorithm to determine, by means of defining a function that correlates the combined signal to a volume of build material 100.

Also, in some cases it may be desirable to have information as to when a set of the transducers 123 pass from the build material interface 122 to the air interface 121. This is particularly interesting, for example, for transducers 123 located in the lower sections of the build unit 12 so that, when it is determined than such a transducer 123 passes from the build material interface 122 to the air interface 121 an alert is triggered to alert the user of a low level of build material 100.

One example of how to accomplish this is by, calculating the gradients for determined periods of time Δ₁, Δ₂, Δ₃ and, if the gradient exceeds a threshold value, it means that at least one sensor has passed from the build material interface 122 to the air interface 121. This can be done for the combined signal 15 or for individual signals taken from each of the transducers 121, once a gradient for a signaling transducer selected from the plurality of transducers exceeds a threshold value, a signal is emitted indicating that the level of build material corresponds to the position of the signaling transducer.

In an example, the build material 100 can be a powder, however, in other examples the build material 100 can be a liquid, at least, while it is stored in the build unit.

The examples of FIGS. 2 and 3 has been described in view of a three-sensor arrangement, however, it is to be noted that this is for the ease of explanation and different examples may comprises more or less sensors. For example, the transducers may be located in a strip of transducers that can be located at least partially along the height of the build unit 12.

Also, in an example, the build unit 12 comprises a set of heaters to perform a pre-heating on the build material. Nonetheless, in another examples the heaters may be located outside the build unit 12 and be located, for example, in the printer 13 of be external devices attachable to the build unit 12.

Also, even though the examples are based temperature transducers, examples can comprise other type of transducers such as, e.g., conductivity transducers, reflectivity transducers, magneto restrictive transducers, acoustic transducers, etc.

In essence a storage module of a 3D printing system is disclosed wherein such in module comprises a plurality of transducers located at different sensing positions within the storage module being the plurality of transducers connected to a processor; wherein a combined signal of the plurality of temperature transducers is determined and the processor is to correlate the combined signal to an amount of build material inside the storage module.

In an example, the plurality of transducers are temperature transducers such as, e.g., thermistors which are preferably NTC thermistors. Also, such transducers may be connected in series, the combined signal being the signal obtained from measuring the transducers in series. Therefore, the combined signal in the case would be the addition of the signals of each of the transducers.

Another way of generating the combined signal may be through a processor wherein the processor combines at least part of the signals of the transducers thereby determining the combined signal. For example, only the signals that exceed a determined threshold are combined to obtain the combined signal, thereby an addition of the signals of the transducers that exceed a predetermined threshold may provide information to calculate the amount of material present in the storage container.

Furthermore, the correlation may be performed e.g., by a processor and, by means of a look-up table correlate a determined temperature (for example, the mean temperature across the storage container) with an amount of build material on the storage container.

In another example, the processor may also be used to detect a gradient within the combined signal or at least one of the transducers. In this manner, once a gradient for a transducer within the plurality of transducers exceeds a threshold value, a signal may be emitted indicating that the level of build material corresponds to the position of the transducer exceeding the threshold.

On the other hand, a method for the determination of a level of build material within a build unit is disclosed wherein the build unit comprises
a storage module to store build material;
a plurality of transducers located at different sensing positions within the storage module;
   wherein the method comprises: determining a combined signal by combining the signals of the plurality of temperature transducers; and correlating the combined signal to an amount of build material inside the storage module.

The combination of the signal of the plurality of transducers can be hardware combination (e.g., by connecting the transducer in series) or by computer implemented means (e.g., transferring the individual signals to a processor that post-processes this signals).

As mentioned above, the correlation of the data to determine the amount of build material on the storage unit can be performed using a look-up table. Alternatively, the correlation from the combined signal to a build material level comprises using a function.

1. A storage module of a 3D printing system comprising a plurality of transducers located at different sensing positions within the storage module the plurality of transducers being connectable to a processor; wherein a combined signal of the plurality of temperature transducers is determined and the processor is to correlate the combined signal to an amount of build material inside the storage module.

2. A storage module, according to claim 1, wherein the plurality of transducers are temperature transducers.

3. A storage module, according to claim 1 wherein the transducers are connected in series, the combined signal being the signal obtained from measuring the transducers connected in series.

4. A storage module, according to claim 1 wherein the transducers are connected to the processor and the processor combines at least part of the signals of the transducers thereby determining the combined signal.

5. A storage module, according to claim 4, wherein only the signals that exceed a determined threshold are combined to obtain the combined signal.

6. A storage module, according to claim 1, wherein the correlation performed by the processor comprises using a look-up table.

7. A storage module, according to claim 1, wherein the processor is to detect a gradient within the combined signal or at least one of the signals of the transducers.

8. A storage module, according to claim 7 wherein once a gradient for a transducer within the plurality of transducers exceeds a threshold value, a signal is issued indicating that the level of build material corresponds to the position of the signaling transducer.

9. Method for the determination of a level of build material within a 3D printing system wherein the system comprises
a storage module to store build material;
a plurality of transducers located at different sensing positions within the storage module;
wherein the method comprises: determining a combined signal by combining the signals of the plurality of temperature transducers; and correlating the combined signal to an amount of build material inside the storage module.

10. A method according to claim 9 wherein the determining of the combined signal is obtained by transducers connected in series.

11. A method according to claim 10 wherein the determining of the combined signal comprises a computer implemented combination.

12. A method according to claim 11, wherein the computer implemented combination comprises the addition of at least some of the signals of the plurality of transducers.

13. A method, according to claim 9, wherein the method comprises detecting a gradient within the combined signal.

14. A method, according to claim 9, wherein the method comprises detecting a gradient within the signal of at least one of the transducers.

15. A 3D printing system comprising:
a storage module to store build material;
a plurality of transducers located at different sensing positions within the storage module being the plurality of transducers connected to a processor;
wherein a combined signal of the plurality of temperature transducers is determined and the processor is to correlate the combined signal to an amount of build material inside the storage module
